(19) United States
(12) Patent Application Publication
(10) Pub. No.: US 2006/0126113 A1
(43) Pub. Date: Jun. 15, 2006

(54) Printing apparatus, and control method and control program of the apparatus

(75) Inventor: Sadatoshi Narazaki, Chiba-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/295,420

(22) Filed: Dec. 6, 2005

(30) Foreign Application Priority Data
Dec. 10, 2004 (JP) 2004-357498

(51) Int. Cl. G06F 3/12

(52) U.S. Cl. 358/1.15; 358/539

(57) ABSTRACT

A printing apparatus reads out and prints image data from a specified image file stored in a predetermined format, including image data captured by digital cameras which has additional predetermined information. The printing apparatus includes a two-dimensional code generating unit configured to encode the additional predetermined information contained in the specified image data and print setting information indicating print conditions set for printing the image data into a two-dimensional code; and a printing unit configured to print an image of the generated two-dimensional code along with an image of the specified image data.

### BACKGROUND OF THE INVENTION

1. Field of the Invention

The present invention relates to printing apparatuses and, more particularly, to a printing apparatus printing an image of image data captured by a digital camera, a control method of the printing apparatus, and a control program of the printing apparatus.

2. Description of the Related Art

Printing apparatuses that receive memory cards in which image data captured by digital cameras or the like is stored in memory card slots provided therein to read out the image data and to print the readout image data have been available. In addition, printing apparatuses directly connected to digital cameras supporting PictBridge, which is an industry open standard, to print image data have already been put into practical use.

Standards of image data recording formats with regard to storage of pictures (images) captured by digital cameras include Exchangeable Image File Format (hereinafter abbreviated as Exif). The names of the image files, the date and time when the images are captured, thumbnails (reduced images), and setting information about the digital cameras in the capture of the images are added to the image data in the image files stored in the digital cameras supporting the Exif as Exif information about the images. The setting information about the digital cameras includes an exposure, a white balance setting, an aperture value, a shutter speed, a sharpness setting, and a contrast setting. A printing apparatus that uses the Exif information to perform printing as intended by a photographer is disclosed in, for example, Japanese Patent Laid-Open No. 2004-64464 (corresponding to U.S. Patent Application Publication No. 2004-0021884).

Although the Exif information can be used to perform the printing as intended by the photographer with such a printing apparatus, it is not possible to acquire the Exif information from the print on which only the images are printed and, therefore, to acquire the setting information intended by the photographer in the printing of the images.

[Conventional Print Method]

In order to resolve the above problem, as shown in FIG. 8, a print method in which an image 82 of image data captured by a digital camera is printed on print paper 81 and text 83 indicating the Exif information added to the image data is also printed on the print paper 81 has been developed. In this print method, the text 83 can be watched to acquire the setting information in the capture of the image and to determine the intent of the photographer.

However, although the setting information in the capture of the image 82 can be acquired from the text 83 in the above print method, the setting information indicating print conditions (hereinafter referred to as “print setting information”) set by the user in the printing of the image 82 cannot be acquired.

For example, recent printing apparatuses, such as inkjet printers, have a function of automatically correcting a darker image to a lighter image or automatically correcting a duller image to a brighter image to print the corrected image. Although using a function of correcting an image to an optimized image of such a printing apparatus reduces the number of failures in the printing, the image intended by the photographer is not necessarily printed and there are cases in which the correction is not performed according to the intention of the user. If the print setting information including whether the correction is performed cannot be acquired, it is not possible to print the image 82 again in the same print conditions as in the printing of the image 82 to yield a print image identical to the image 82 (hereinafter referred to as exact copy of an image).

Although there is a method of recording the print setting information in a notepad in order to resolve such a problem, it is troublesome to create a memo and it is necessary to manage the memo so as not to be missed.

Accordingly it is desirable to provide a print method in which the image of the image data captured by the digital camera and the text indicating the Exif information are printed on the print paper, and text indicating the print setting information of the image is also printed on the print paper.

[Larger Space Requirement Causing Disfigurement]

It is also recognized that a larger space on the print paper 81 is required to print only the text 83 indicating the Exif information in FIG. 8. Further printing the text indicating the print setting information considerably limits a space available in the printing of the image 82 to reduce the size of the image 82. Although the text indicating the Exif information and the print setting information can be printed in a smaller character size in order to save the space, it becomes difficult to read the characters.

In addition, there are problems in that the presence of the text occupying a larger space disfigures the printed image and, therefore, the image does not pass for photographic printing.

In order to exactly copy the image 82, it is necessary for the user to input the name of the image file including the image data of the image 82 in the printing apparatus by operating the keys and the like while watching the text 83 indicating the Exif information to specify the image 82. It is also necessary for the user to set the print conditions corresponding to the print setting information while watching the print setting information, by operating the keys and the like and, therefore, there is a problem in that a complicated and troublesome operation is required. Even when only the image 82 is specified and the default print conditions of the printing apparatus are used to print the image 82, that is, even in the simple (not exact) copy, a complicated input operation with the keys and the like is required to specify the image.

Therefore, it would be desirable to print additional information contained in specified image data and print setting information set for printing, along with an image of the image data, in a smaller space so as not to disfigure the image of the image data in a printing apparatus that prints the image data captured by a digital camera. It is also desirable to easily perform exact copy of the printed image of the image data.

[Index Printing]

And still yet in another scenario, a printer adopts printing of an image file in a list form, that is, index printing, in which, as shown in FIG. 10, reduced images 102 of the image data in multiple image files captured by the digital camera and the names 103 of the image files are printed on print paper 101. The user specifies an image to be printed in the list to print the image. The user may input the name of a desired image file, for example, “DSC01.JPG” by operating keys or the like to specify the image. Alternatively, the user may input a check mark in a desired check box among check mark boxes (not shown) printed near the names 103 of the image files and the input check mark may be read by a scanner to determine the desired image file.

However, it is necessary for the user to perform a complicated operation in order to specify a desired image file and it is not easy to specify the image file in the above methods. In addition, since the print setting information contained in the original images of the reduced images 102 is unknown, it is not possible to exactly copy the image.

Therefore, it would also be desirable to resolve the aforementioned problems affiliated with index printing.

### SUMMARY OF THE INVENTION

According to an embodiment of the present invention, a printing apparatus that reads out and print image data from a specified image file stored in a predetermined format, including the image data captured by digital cameras which has additional predetermined information, includes a two-dimensional code generating unit configured to encode the additional predetermined information contained in the specified image data and print setting information indicating print conditions set for printing the image data into a two-dimensional code; and a printing unit configured to print an image of the generated two-dimensional code along with an image of the specified image data.

The printing apparatus may further include a receiving unit configured to receive the additional predetermined information and the print setting information transmitted from an external device including an image reader reading the image of the two-dimensional code, a two-dimensional code analyzer analyzing the read image of the two-dimensional code to decode the additional predetermined information and the print setting information, and a transmitter transmitting the decoded additional predetermined information and print setting information; a searching unit configured to search the image files stored in the storage medium for an image file associated with the received additional predetermined information; and a printing unit configured to print the image of the image data in the searched image file under the print conditions set in accordance with the received print setting information.

The printing apparatus may further include a receiving unit configured to receive image data of the two-dimensional code transmitted from an external device including an image reader reading the image of the two-dimensional code and a transmitter transmitting the image data of the read two-dimensional code; a two-dimensional code analyzing unit configured to analyze the image of the received image data of the two-dimensional code to decode the additional predetermined information and the print setting information; a searching unit configured to search the image files stored in the storage medium for an image file associated with the decoded additional predetermined information; and a printing unit configured to print the image of the image data in the searched image file under the print conditions set in accordance with the decoded print setting information.

The printing apparatus may further include an image reading unit configured to read the image of the two-dimensional code; a two-dimensional code analyzing unit configured to analyze the read image of the two-dimensional code to decode the additional predetermined information and the print setting information; a searching unit configured to search the image files stored in the storage medium for an image file associated with the decoded additional predetermined information; and a printing unit configured to print the image of the image data in the searched image file under the print conditions set in accordance with the decoded print setting information.

According to other embodiments of the present invention, a control method for the printing apparatus a computer readable medium, corresponding to the structure of the above printing apparatus, are provided.

Further aspects and features of the present invention will become apparent from the following description of exemplary embodiments with reference to the attached drawings.

### BRIEF DESCRIPTION OF THE DRAWINGS

FIG. 1 is a perspective view showing an exemplary structure of a printing system including a printer according to an aspect of the present invention, a mobile telephone, and a memory card.

FIG. 2 is a block diagram showing an exemplary structure of the control system of the printer and the mobile telephone.

FIG. 3 shows part of Exif information.

FIG. 4 shows part of print setting information.

FIG. 5 shows an example of a QR code.

FIG. 6A is a flowchart showing an exemplary control process of generating and printing the QR code.

FIG. 6B is a flowchart showing an exemplary control process of reading and copying/printing the QR code.

FIG. 7 shows an example of a printed image.

FIG. 8 shows an example of a printed image.

FIG. 9 shows an example of index printing.

FIG. 10 shows an example of the index printing.

FIG. 11 is a flowchart showing an exemplary control process of printing the Exif information and the print setting information along with an image.

### DESCRIPTION OF THE EMBODIMENTS

Numerous embodiments, features and aspects of the present invention will be described with reference to the attached drawings. For example, several embodiments in a printing apparatus that prints image data captured by a digital camera supporting Exif will be described herein.

### First Exemplary Embodiment

According to a first exemplary embodiment of the present invention, a print method is provided in which the image 82 of the image data captured by the digital camera and the text 83 indicating the Exif information are printed on the print paper 81, as described above with reference to FIG. 8, and a text indicating the print setting information (refer to FIG. 4) of the image 82 is also printed on the print paper 81.

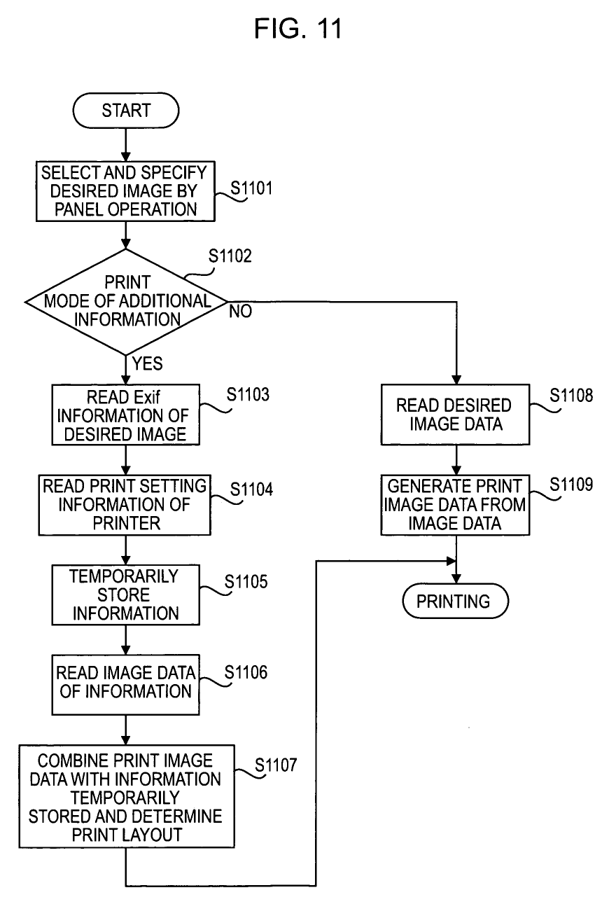

This first exemplary print method is performed in accordance with, for example, a control process shown in FIG. 11, performed by the printing apparatus. In Step S1101, a user operates keys and the like on an operation panel of the printing apparatus to display, for example, reduced images of image data stored in a memory card loaded in the printing apparatus in a display unit of the printing apparatus. The user selects and specifies image data to be printed among the displayed reduced images and sets various print conditions used for printing an image of the image data. In addition, the user sets a mode in which the Exif information added to the image data and the print setting information are printed or a mode in which the Exif information and the print setting information are not printed.

In Step S1102, a control unit of the printing apparatus determines whether the mode in which the Exif information and the print setting information are printed is set. If the mode is not set, then in Step S1108, the process reads out the image data selected in Step S1101 from the memory card. In Step S1109, the process converts the image data, for example, data in Joint Photographic Experts Group (JPEG) format, into data in a data format printable with the printing apparatus to generate print image data and to print an image of the print image data. The generation and printing of the print image data is based on the conditions set in accordance with the print setting information. Only an image of the image data is printed and a text indicating the Exif information and the print setting information is not printed in this step.

If the mode in which the Exif information and the print setting information are printed is set in Step S1102, the process proceeds to Steps S1103 to S1107.

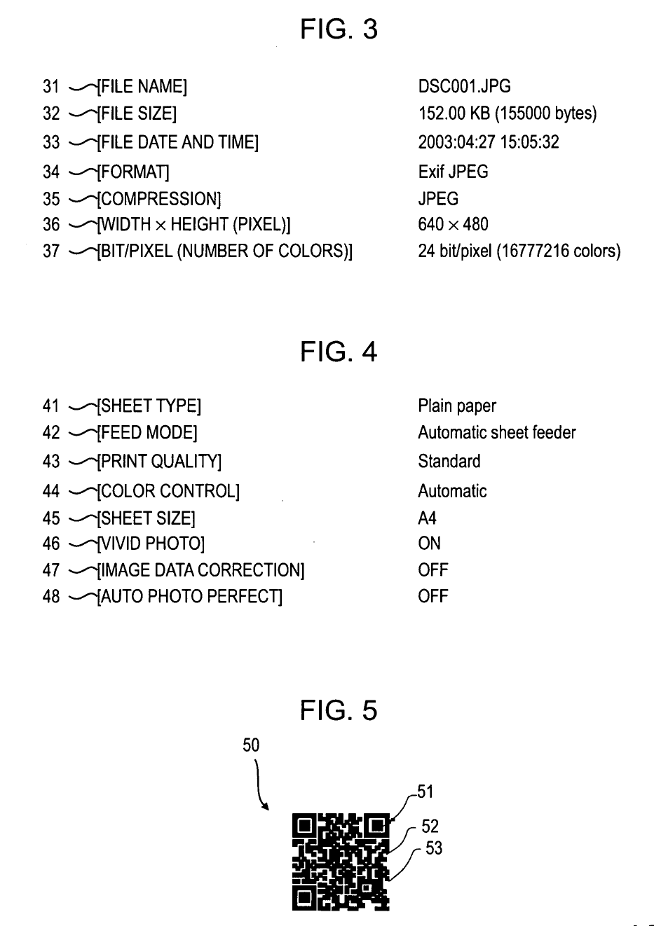

In Step S1103, the process reads out the Exif information, as shown in FIG. 3, added to the image file selected in the memory card. FIG. 3 shows part of the Exif information contained in image data that is captured by the digital camera and that is stored in the memory card 111. Referring to FIG. 3, reference numeral 31 denotes a file name of the image data (DSCO01.JPG), reference numeral 32 denotes a file size (152.00 KB), and reference numeral 33 denotes a file date and time when the image data is captured (2003:04:27 15:05:32). Reference numeral 34 denotes a file format (Exif JPEG), reference numeral 35 denotes a compression format (JPEG), reference numeral 36 denotes the number of pixels in width and height (640×480), and reference numeral 37 denotes a bit/pixel ratio (24 bit/pixel). The Exif information further includes a manufacturer name of the digital camera, a device name, an exposure time, and use of flash.

In Step S1104, the process reads out the print setting information, as shown in FIG. 4, set by the user in Step S1101. FIG. 4 shows part of the print setting information indicating various print conditions of the printer 100, set by the user when the image data in a desired image file in the memory card 111 is printed with the printer 100. Referring to FIG. 4, reference numeral 41 denotes a sheet type (plain paper), reference numeral 42 denotes a feed mode (automatic sheet feeder), and reference numeral 43 denotes print quality (standard). Reference numeral 44 denotes color control (automatic), reference numeral 45 denotes a sheet size (A4), reference numeral 46 denotes the setting of Vivid Photo (ON), reference numeral 47 denotes the setting of image data correction (OFF), and reference numeral 48 denotes the setting of Auto Photo Perfect (OFF). The print setting information further includes other setting information depending on the printer. Although these settings are set in states that are often used for every printer as initial values, for example, the presence of image correction may be changed depending on the preference of the user.

In Step S1105, the process temporarily stores the Exif information read out in Step S1103 and the print setting information read out in Step S1104 in the memory. In Step S1106, the process reads out the image data selected in Step S1101 from the image data in the memory card. In Step S1107, the process converts the readout image data, for example, the data in the JPEG format, into data in a data format printable with the printing apparatus. The process corrects the image data on the basis of a variety of correction setting information included in the print setting information. In addition, the process combines text information including the Exif information and the print setting information with the image data after the image correction. The process determines a print layout, generates print image data, and prints the print image data under the print conditions set in accordance with the print setting information.

As a result, as shown in FIG. 8, the image 82 of the image data and the text 83 indicating the Exif information are printed on the print paper 81. Although not shown in FIG. 8, a text indicating the print setting information, as shown in FIG. 4, is also printed. Moreover, the user can determine the print setting information contained in the printed image 82 and can print the image 82 again in the same conditions as in the printing of the image 82 to exactly copy the image 82.

### Second Exemplary Embodiment

The second exemplary embodiment is provided to further overcome disadvantages regarding the need for a larger space on the print paper 81 which is required to print only the text 83 indicating the Exif information in FIG. 8. In particular, in the second embodiment, additional information contained in specified image data and print setting information set for printing, along with an image of the image data, is printed in a smaller space so as not to disfigure the image of the image data in a printing apparatus that prints the image data captured by a digital camera. The second embodiment is now herein described in greater detail.

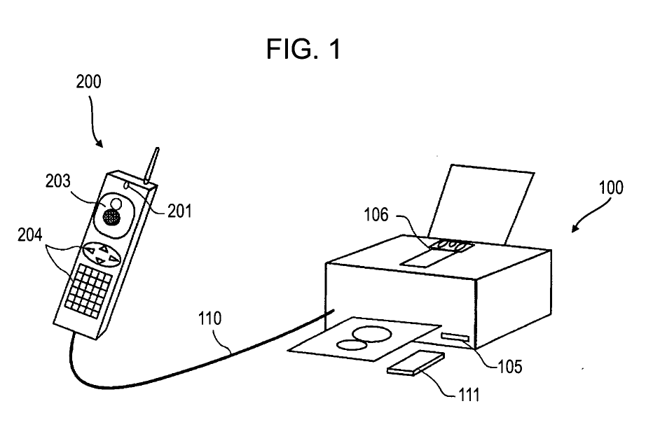

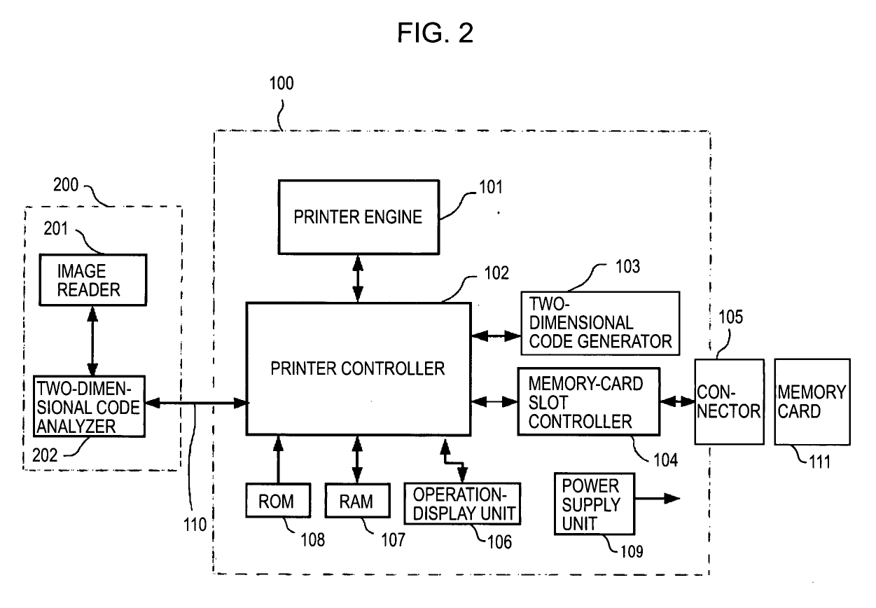

FIG. 1 is an external view of a printing system including a printing apparatus (hereinafter referred to as a “printer”) 100 according to the second embodiment of the present invention and a mobile phone 200, which is a portable terminal device having a function of reading a two-dimensional code. FIG. 2 is a block diagram showing an exemplary structure of the control system of the printing system. The printer 100 is provided with a memory card 111, which is a removable storage medium for a digital camera (not shown).

Referring to FIG. 1, the mobile telephone 200 is connected to the printer 100 via a cable 110 connected to a connector for external connection (not shown) of the printer 100. Since many printers are provided with universal serial bus (USB) connectors serving as dedicated interfaces with digital cameras in recent years, for example, a USB cable may used as the cable 110. The printer 100 is capable of receiving Exif information and print setting information, resulting from analysis and decoding of two-dimensional code described below, from the mobile telephone 200 through the cable 110.

Referring to FIG. 2, the printer 100 includes a printer engine (printer mechanism) 101, a printer controller (CPU/dedicated circuit) 102, a two-dimensional code generator 103, a memory-card slot controller 104, a connector 105, an operation-display unit 106, a RAM 107, a ROM 108, and a power supply unit 109.

The printer engine 101 performs printing on a print sheet and includes a print head, a print head driving mechanism, a feeding mechanism of the print sheet, drive motors of the above components, and so on.

The printer controller 102 controls the printer 100. The printer controller 102, for example, controls driving of the printer engine 101 and reads out image data captured by the digital camera from the memory card 111 loaded in the connector 105 and converts the readout image data into printable data format. The printer controller 102 includes, for example, a central processing unit (CPU), which is a microcontroller, and a dedicated circuit (application specific integrated circuit) (ASIC). The memory card 111 is formed of, for example, a semiconductor memory or a hard disk.

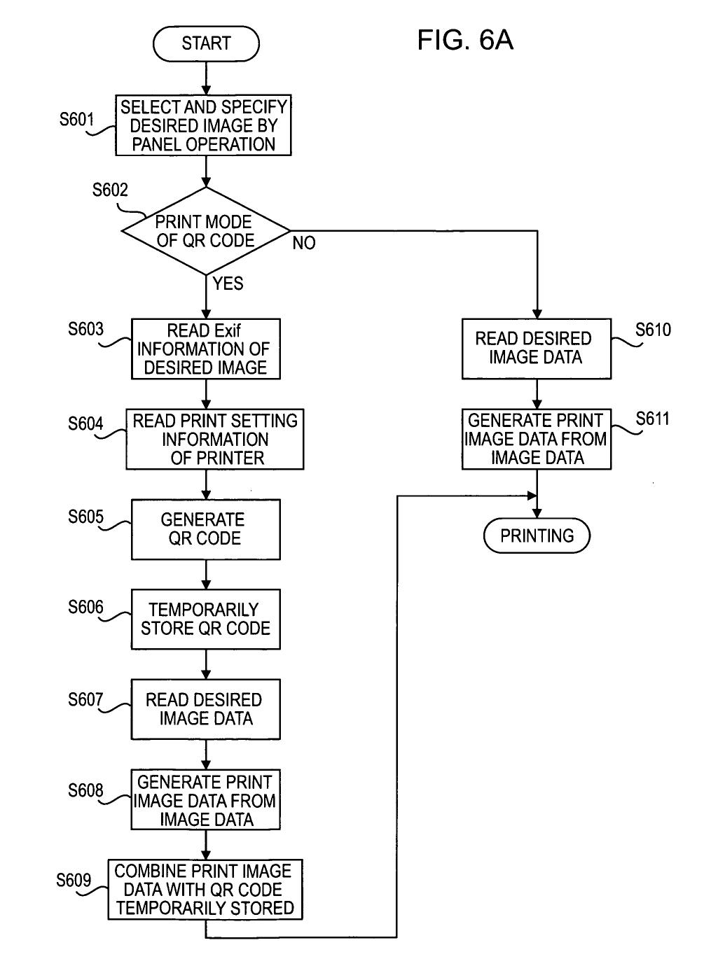

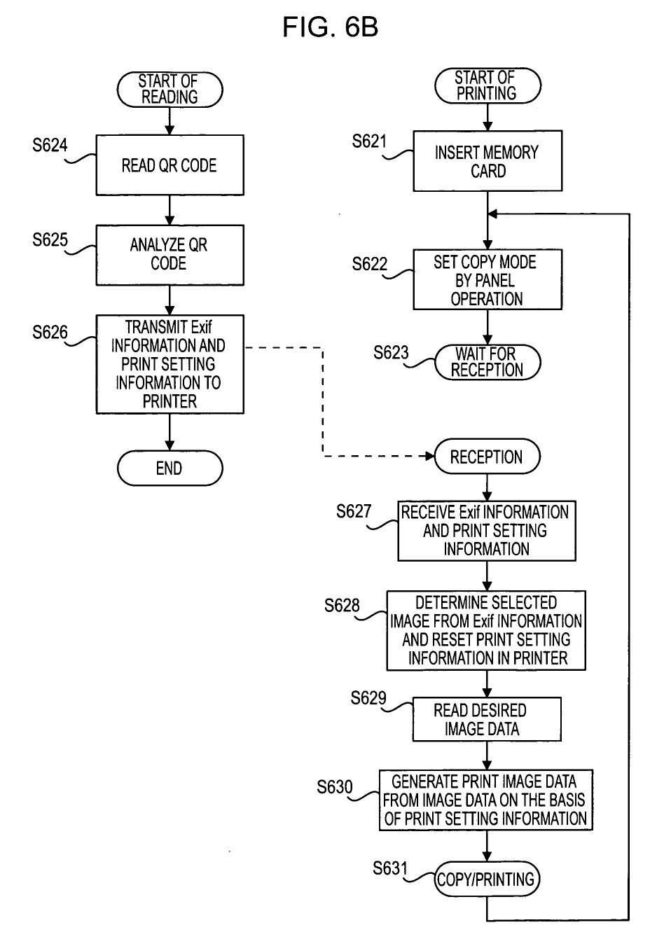

The ROM 108 is a program memory in which data including constants and variables for operating the printer controller 102 is stored. Control programs executed by the printer controller 102, the two-dimensional code generator 103, and the memory-card slot controller 104 are stored in the ROM 108. The control programs executed by the printer controller 102 include control programs corresponding to control processes shown in FIGS. 6A and 6B, which will be described later in the specification.

The two-dimensional code generator 103 encodes the Exif information, which is additional information contained in the image data stored in the memory card 111 loaded in the connector 105, and the print setting information concerning the printer controller 102, stored in the RAM 107, to generate a two-dimensional code.

The memory-card slot controller 104 controls reading and writing of stored information, such as the image data stored in the memory card 111 loaded in the connector 105. The memory-card slot controller 104 uses, for example, an adopter of changing the shape of a connector to support various memory cards including a Personal Computer Memory Card International Association (PCMCIA) memory card and a compact memory card. The printer 100 may include a memory-card slot controller supporting various memory cards without using the adaptor of changing the shape of the connector.

The connector 105 is a memory card connector. A PCMCIA card connector, which is standardized by industry, is generally used as the connector 105. For example, the connector 105 is provided on the front face of the printer 100, as shown in FIG. 1, which the memory card 111 is removably loaded in and connected to.

The operation-display unit 106 is an operation panel that operates the printer 100 to display data in the printer 100. The operation panel 106 includes an operation unit including various switches, for example, a power supply switch for the printer 100, and various keys, a light emitting diode (LED) used for displaying a status of the apparatus, a liquid crystal display (LCD) displaying an image of the image data stored in the memory card 111, and so on. The operation panel 106 is provided, for example, on the top face of the printer 100, as shown in FIG. 1.

The RAM 107 serves as a storage unit used as a working memory or a temporary storage device when the CPU of the printer controller 102 operates.

The power supply unit 109 includes an alternating-current power supply or a direct-current power supply, such as a battery (not shown). The power supply unit 109 supplies power to the above components in the printer 100.

The mobile telephone 200 includes an image reader 201, which is a small digital camera reading the image of the two-dimensional code, and a two-dimensional code analyzer 202 analyzing the read image of the two-dimensional code to decode the original information. The mobile telephone 200 also includes a display unit 203 (refer to FIG. 1) displaying a variety of information including the information decoded by the two-dimensional code analyzer 202 and operation keys 204 (refer to FIG. 1) used by a user to input various instructions. The mobile telephone 200 further includes a memory (not shown) in which information including the information decoded by the two-dimensional code analyzer 202 is stored and a control unit (not shown) controlling the entire operation of the mobile telephone 200. The information decoded by the two-dimensional code analyzer 202 is transmitted to the printer 100 through the cable 110 under the control of the control unit. The information may be transmitted from the mobile telephone 200 to the printer 100 via wireless communication.

According to the second embodiment of the present invention, the two-dimensional code resulting from the encoding of the Exif information shown in FIG. 3 and the print setting information shown in FIG. 4 is used.

A quick response code (QR code) shown in FIG. 5 is exemplified as the two-dimensional code in the second embodiment. However, matrix two-dimensional codes including MaxiCode and Data Matrix, other than the QR code, and stack-type two-dimensional codes including PDF417 may be used in the embodiments of the present invention.

A QR code 50 shown in FIG. 5 is a matrix barcode including a data area 52 and three position detection patterns 51. The data area 52 includes cells 53. The QR code 50 can be read in any direction owing to the three square position detection patterns 51 provided therein. Kanji characters, which cannot be encoded in barcodes in related arts, can be encoded as information in the QR code 50, and an increased amount of information can be encoded in the QR code 50. For example, an about 7,000-digit numeric character, about 4,000 alphanumeric characters, or about 1,800 Kanji characters can be encoded in the QR code 50.

Although the generation of the two-dimensional code in the single printer 100 is described in the second embodiment, the same generating method is applicable to an information processing device, such as a personal computer, or a mobile terminal (not shown) to which the printer 100 is connected. Installing an application program capable of editing the two-dimensional codes in the information processing device or the mobile terminal builds a system that prints the Exif information, which is additional information contained in the image data in the memory card 111, and the print setting information concerning the printer. In addition, a system that two-dimensionally encodes personal information and comments concerning the user and memoranda within the number of characters described above to print the two-dimensional codes may be built.

Image data in a desired image file stored in the memory card 111 is selected and an image of the image data is printed with the printer 100 in the printing system having the structure described above. For the printing, the Exif information added to the image data and the print setting information set for printing the image are encoded to generate the QR code.

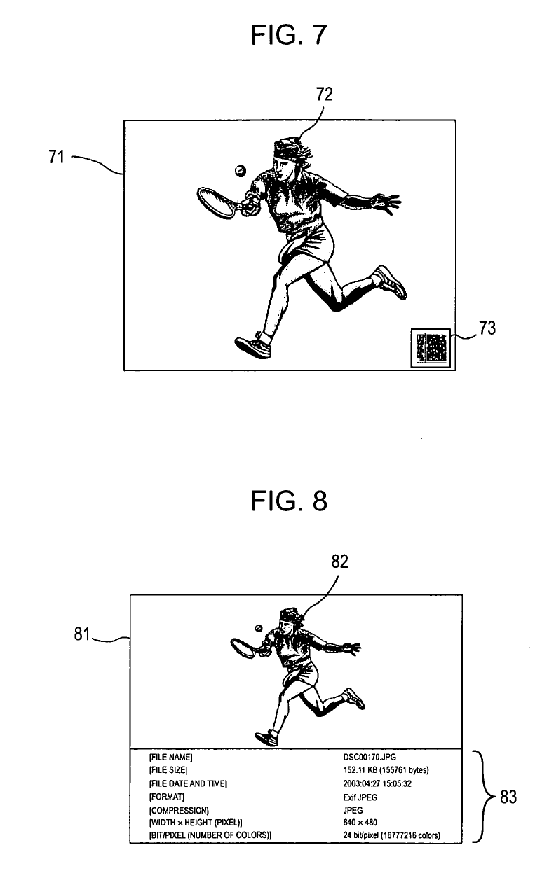

As shown in FIG. 7, an image 72 of the image data and an image of a QR code 73 are printed on print paper 71. The generation and printing of the QR code is performed by the printer controller 102 that executes the control programs stored in the ROM 108 in accordance with an exemplary control process shown in FIG. 6A.

The exemplary control process shown in FIG. 6A is started in a state in which the memory card 111 having the image data captured by the user with the digital camera is loaded in the connector 105 of the printer 100.

In Step S601, the user operates the keys and so on in the operation panel 106 to display reduced images of the image data in each image file stored in the memory card 111 loaded in the connector 105 in the LCD in the operation panel 106 and selects image data to be printed. The user sets various print conditions for printing the image and also sets a mode in which the QR code is printed with the image of the image data or a mode in which the QR code is not printed with the image of the image data. The QR code is generated by encoding the print setting information indicating the set print conditions and the Exif information added to the selected image data. The setting information is stored in predetermined multiple memory addresses in the RAM 107.

In Step S602, the printer controller 102 determines whether the mode in which the QR code is printed is set or whether the mode in which the QR code is not printed is set with reference to the predetermined memory addresses in the RAM 107. If the mode in which the QR code is not printed is set, the process proceeds to Steps S610 and S611.

In Step S610, the process reads out the image data selected in Step S601 from the memory card 111 under the control of the memory-card slot controller 104. In Step S611, the printer controller 102 executes an image data conversion program included in the control programs in the ROM 108. More specifically, the printer controller 102 converts the image data, for example, data in the JPEG format, into data in a data format printable with the printer 100 to generate print image data. The printer controller 102 then drives the printer engine 101 to print an image of the print image data.

If the mode in which the QR code is printed is set in Step S602, the process proceeds to Steps S603 to S609. In Step S603, the process reads out the Exif information added to the image data in the image file selected and specified in the memory card 111. In Step S604, the process reads out the print setting information set by the user in Step S601 from the RAM 107.

In Step S605, the process supplies the Exif information read out in Step S603 and the print setting information read out in Step S604 to the two-dimensional code generator 103 to generate the QR code 50 shown in FIG. 5, resulting from the encoding of the Exif information and the print setting information.

In Step S606, the process temporarily stores the generated QR code in the RAM 107. In Step S607, the process reads out the image data selected and specified in Step S601 from the image data in the image file stored in the memory card 111, as in Step S610.

In Step S608, the process converts the readout image data into data in a data format printable with the printer 100. In addition, the process corrects the image data on the basis of the print setting information shown in FIG. 4, set in Step S601, to generate print image data. Step S608 is similar to Step S611 described above.

In Step S609, the process reads out the QR code temporarily stored in Step S606 and combines the readout QR code with the print image data generated in Step S608 in accordance with a print layout set in advance to generate final print image data. The process drives the printer engine 101 to print an image of the print image data.

In the manner described above, the image 72 of the image data in the selected image file is printed on the print paper 71, and the image of the QR code 73 resulting from the encoding of the Exif information and the print setting information is also printed on the print paper 71, as shown in FIG. 7. The Exif information and the print setting information acquired from the QR code 73 can be used to perform the exact copy. Since a large amount of information can be encoded in the small QR code 73, the QR code 73 is reduced in size as shown in FIG. 7. The QR code 73 in FIG. 7 occupies only a fairly small space compared with a text 83 indicating the Exif information in an example of a printed image in a shown in FIG. 8. Accordingly, the image 72 is not limited in size, unlike an image 82 in the related art, and the image 72 can be printed on the whole area of the print paper 71. The QR code 73 does not disfigure the image 72, unlike the text from FIG. 8.

When the printer 100 according to the second embodiment is capable of two-sided printing, printing the image 72 on the front face and printing the QR code 73 on the rear face allows the QR code 73 not to disfigure the image 72 at all.

The exact copy in which the user reads the image of the QR code 73 printed on the print paper 71 in FIG. 7 with the mobile telephone 200 to print an image identical to the image 72 that has been already printed with the printer 100 will be described. This exact copy is performed by the control unit (not shown) in the mobile telephone 200 and the printer controller 102 in the printer 100 that execute the control programs in accordance with an exemplary control process shown in FIG. 6B.

First, Steps S621 to S623 shown in the right side of FIG. 6B are performed with the printer 100. In Step S621, the user inserts the memory card 111, used in the previous printing of the image 72 and the QR code 73 in FIG. 7, into the connector 105. In Step S622, the user operates the keys and so on in the operation panel 106 to set the print mode of the printer 100 to a copy mode. In Step S623, the process waits for reception of the Exif information and the print setting information from the mobile telephone 200 having a function of reading the QR code.

Next, Steps S624 to S626 shown in the left side of FIG. 6B are performed with the mobile telephone 200. In Step S624, the user operates the keys in the operation panel 106 to set a QR code reading mode, and the image reader 201 reads out the QR code 73. In Step S625, the two-dimensional code analyzer 202 analyzes the QR code 73 to decode the Exif information and the print setting information described above with reference to FIGS. 3 and 4. In Step S626, the process transmits the decoded Exif information and print setting information to the printer 100, which waits for the reception, through the cable 110 and terminates the process.

Finally, Steps S627 to S631 are performed with the printer 100. In Step S627, the process receives the Exif information and the print setting information, which are decoded from the QR code 73, from the mobile telephone 200.

In Step S628, the process checks the file name 31 in the received Exif information, as shown in FIG. 3, to determine the file name including the image of which the user selects the copy. More specifically, in the example shown in FIG. 3, the information indicating the file name DSC001.JPG is acquired from the file name 31. In addition, the setting data, for example, the sheet type 41, the feed mode 42, and the print quality 43 shown in FIG. 4, is replaced (overwritten) with initial data stored in predetermined addresses in the RAM 107 to reset the print setting information used in the previous printing of the image 72 in the printer 100. Although the print setting information is stored in the RAM 107 in the second embodiment, the updated print setting information may be set in a rewritable non-volatile memory if the variety of setting information concerning the printer 100 is stored in the rewritable non-volatile memory, such as an electronically erasable and programmable read only memory (EEPROM).

In Step S629, the process searches the multiple files in the memory card 111 for an image file having the file name identical to the file name determined in Step S628. The process then reads the image data in the image file into the RAM 107.

In Step S630, the process converts the image data read in Step S629 into data in a data format printable with the printer 100. The process then corrects the image data on the basis of the print setting information, as shown in FIG. 4, reset in Step S628, particularly on the basis of the setting information 46, 47, and 48 about the correction. In addition, the process decodes and generates the same print image data under the print conditions including the image correction conditions identical to those of the image 72 printed on the print paper 71 from which the QR code 73 is read.

In Step S631, the process drives the printer engine 101 to print the print image data generated in Step S630, that is, to copy the image 72. Using the sheet type, sheet size, feed mode identical to those in the previous printing of the image 72 on the basis of the print setting information allows an image identical to the image 72 to be printed, that is, allows the exact copy to be performed. After the printing is completed, the process goes back to Step S622.

In this copy and printing, the QR code indicating the Exif information and the print setting information received from the mobile telephone 200 may be generated in the two-dimensional code generator 103 and the generated QR code may be printed again along with the image of the print image data. In this operation, the exact copy and printing can be realized from the print paper on which the exact copy and printing is performed. Also in this case, the image of the print image data is not limited in size and the image is not disfigured by the QR code, as in the previous printing.

As described above, according to the second embodiment, in order for the user to perform the exact copy of the image 72 in FIG. 7, which has been captured with the digital camera and has been printed, it is sufficient for the user to use the mobile telephone 200 to read the QR code 73 printed along with the image 72. Unlike the related arts, there is no need to input the file name of the image file including the image data about the image 72 by operating the keys or the like to specify the image 72. In addition, it is not necessary to set the same various print conditions as in the previous printing of the image 72, thus realizing simple printing.

Although the mobile telephone 200 is used as a device for reading and analyzing the QR code in the first embodiment, a digital camera or an image scanner having a function of analyzing the QR code may be used instead of the mobile telephone 200. A general QR code reader may be used.

Alternatively, a two-dimensional code analyzer may be included in the printer 100, that is, an analysis program may be stored in the ROM 108 in the printer 100, and the printer controller 102 may execute the analysis program to analyze the QR code. In this case, the mobile telephone 200 does not need to have a function of analyzing the QR code and only transmitting the image data of the captured QR code, read by the image reader 201, to the printer 100 activates the system. The same applies to a case where the digital camera or the image scanner is used instead of the mobile telephone 200.

Furthermore, when the printer 100 is built as a digital multifunction machine having a scanner function, the printer 100 may read and analyze the image of the QR code.

Therefore, according to the second exemplary embodiment, additional information contained in specified image data and print setting information set for printing, along with an image of the image data, is printed in a smaller space so as not to disfigure the image of the image data in a printing apparatus that prints the image data captured by a digital camera. It is also desirable to easily perform exact copy of the printed image of the image data.

### Third Exemplary Embodiment

According to a third exemplary embodiment of the present invention, the problems affiliated with index printing (as discussed in the Background Section) can also be resolved by the use of the technology of using the QR code in the system shown in FIGS. 1 and 2.

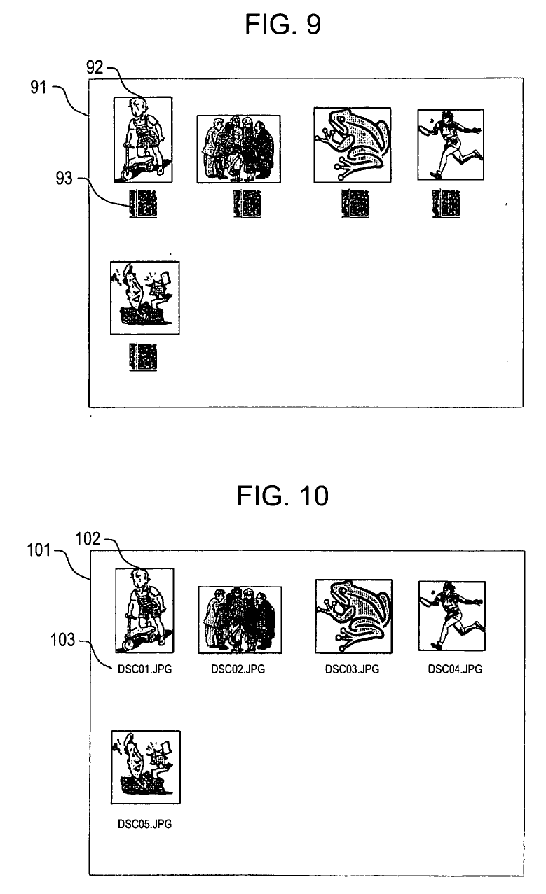

FIG. 9 shows an example of the index printing according to the third embodiment of the present invention. When the index printing is specified, reduced images 92 of the image data in all the image files stored in the memory card 111 are printed on print paper 91 with the printer 100. In addition, QR codes 93 resulting from the encoding of the Exif information contained in all the images and the print setting information used for printing the images with the printer 100 are printed near the reduced images 92 on the print paper 91. With regard to the print setting information to be encoded, the print setting information stored in the printing prior to the index printing is encoded for the images that have been printed prior to the index printing while the default print setting information is encoded for the images that have not been printed prior to the index printing.

The user reads the QR code 93 of the reduced image 92 of a desired image, for example, the QR code 93 of the upper leftmost image in FIG. 9, printed on the print paper 91 on which the index printing has been performed with the mobile telephone 200 to print the desired image, and the exact copy is achieved in exactly the same conditions as in the previous printing.

According to the third embodiment, it is sufficient for the user to read the QR code with the mobile telephone 200 in order to specify a desired image in the index printing and the image can be easily specified. In addition, the exact copy can be easily performed, as described above.

### Other Exemplary Embodiments, Aspects and Features of the Present Invention

According to another embodiment of the present invention, it is possible to print the images indicating the additional information and the print setting information contained in the image data in small spaces in the form of the two-dimensional codes, along with the images of the specified image data, so as not to disfigure the images of the image data, and it is also possible to acquire and use the additional information and the print setting information from the two-dimensional codes.

According to other embodiments of the present invention, it is possible for the user to search for the file including a desired image data and to automatically set the same print conditions only by reading the two-dimensional code printed along with the printed image of the desired image data, thus advantageously and easily realizing the exact copy of the image of the desired image data.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-357498 filed Dec. 10, 2004, which is hereby incorporated by reference herein in its entirety.

What is claimed is:

1. A printing apparatus configured to read out and print image data from a specified image file stored in a predetermined format, including image data captured by digital cameras which has additional predetermined information, the printing apparatus comprising:
a two-dimensional code generating unit configured to encode the additional predetermined information contained in the specified image data and print setting information indicating print conditions set for printing the image data into a two-dimensional code; and
a printing unit configured to print an image of the generated two-dimensional code along with an image of the specified image data.

2. The printing apparatus according to claim 1, wherein the predetermined additional information includes a file name.

3. The printing apparatus according to claim 1, further comprising,
a receiving unit configured to receive the additional predetermined information and the print setting information transmitted from an external device including,
an image reader configured to read the image of the two-dimensional code;
a two-dimensional code analyzer configured to analyze the read image of the two-dimensional code to decode the additional predetermined information and the print setting information; and
a transmitter configured to transmit the decoded additional predetermined information and print setting information;
a searching unit configured to search the image files stored in a storage medium for an image file associated with the received additional predetermined information; and
a printing unit configured to print the image of the image data in the searched image file under the print conditions set in accordance with the received print setting information.

4. The printing apparatus according to claim 1, further comprising:
a receiving unit configured to receive image data of the two-dimensional code transmitted from an external device including,
an image reader configured to read the image of the two-dimensional code; and
a transmitter configured to transmit the image data of the read two-dimensional code;
a two-dimensional code configured to analyze unit configured to analyze the image of the received image data of the two-dimensional code to decode the additional predetermined information and the print setting information;
a searching unit configured to search the image files stored in a storage medium for an image file associated with the decoded additional predetermined information; and
a printing unit configured to print the image of the image data in the searched image file under the print conditions set in accordance with the decoded print setting information.

5. The printing apparatus according to claim 1, further comprising,
an image reading unit configured to read the image of the two-dimensional code;
a two-dimensional code configured to analyze unit configured to analyze the read image of the two-dimensional code to decode the additional predetermined information and the print setting information;
a searching unit configured to search the image files stored in a storage medium for an image file associated with the decoded additional predetermined information; and
a printing unit configured to print the image of the image data in the searched image file under the print conditions set in accordance with the decoded print setting information.

6. The printing apparatus according to claim 1, wherein the predetermined format is Exif.

7. A control method for a printing apparatus configured to read out and print image data from a specified image file stored in a predetermined format, including image data captured by digital cameras which includes additional predetermined information, the control method comprising:
encoding the additional predetermined information contained in the specified image data and print setting information indicating print conditions set for printing the image data into a two-dimensional code; and
printing an image of the generated two-dimensional code along with an image of the specified image data.

8. The control method according to claim 7, wherein the additional predetermined information includes a file name.

9. The control method according to claim 7, further comprising,
receiving the additional predetermined information and the print setting information transmitted from an external device including,
an image reader configured to read the image of the two-dimensional code;
a two-dimensional code analyzer configured to analyze the read image of the two-dimensional code to decode the additional predetermined information and the print setting information; and
a transmitter configured to transmit the decoded additional predetermined information and print setting information;
searching the image files stored in a storage medium for an image file associated with the received additional predetermined information; and
printing the image of the image data in the searched image file under the print conditions set in accordance with the received print setting information.

10. The control method according to claim 7, further comprising,
receiving image data of the two-dimensional code transmitted from an external device including,
an image reader configured to read the image of the two-dimensional code, and
a transmitter configured to transmit the image data of the read two-dimensional code;
analyzing the image of the received image data of the two-dimensional code to decode the additional predetermined information and the print setting information;
searching the image files stored in a storage medium for an image file associated with the decoded additional predetermined information; and
printing the image of the image data in the searched image file under the print conditions set in accordance with the decoded print setting information.

11. The control method according to claim 7, further comprising,
reading the image of the two-dimensional code;
analyzing the read image of the two-dimensional code to decode the additional predetermined information and the print setting information;
searching the image files stored in a storage medium for an image file associated with the decoded additional predetermined information; and
printing the image of the image data in the searched image file under the print conditions set in accordance with the decoded print setting information.

12. A computer readable medium containing computer-executable instructions for controlling a printing apparatus configured to read out and print image data from a specified image file stored in a predetermined format, including image data captured by digital cameras which includes additional predetermined information, the computer readable medium comprising:
computer-executable instructions for encoding the additional predetermined information contained in the specified image data and print setting information indicating print conditions set for printing the image data to generate a two-dimensional code; and
computer-executable instructions for printing an image of the generated two-dimensional code along with an image of the specified image data.

13. The computer readable medium according to claim 12, further comprising,
computer-executable instructions for receiving the additional predetermined information and the print setting information transmitted from an external device including an image reader reading the image of the two-dimensional code, a two-dimensional code analyzer analyzing the read image of the two-dimensional code to decode the additional predetermined information and the print setting information, and a transmitter transmitting the decoded additional predetermined information and print setting information;
computer-executable instructions for searching the image files stored in a storage medium for an image file associated with the received additional predetermined information; and
computer-executable instructions for printing the image of the image data in the searched image file under the print conditions set in accordance with the received print setting information.

14. The computer readable medium according to claim 12, further comprising,
computer-executable instructions for receiving image data of the two-dimensional code transmitted from an external device including an image reader reading the image of the two-dimensional code and a transmitter transmitting the image data of the read two-dimensional code;
computer-executable instructions for analyzing the image of the received image data of the two-dimensional code to decode the additional predetermined information and the print setting information;
computer-executable instructions for searching the image files stored in a storage medium for an image file associated with the decoded additional information; and
computer-executable instructions for printing the image of the image data in the searched image file under the print conditions set in accordance with the decoded print setting information.

15. The control program computer readable medium according to claim 12, further comprising,
computer-executable instructions for reading the image of the two-dimensional code;
computer-executable instructions for analyzing the read image of the two-dimensional code to decode the additional predetermined information and the print setting information;
computer-executable instructions for searching the image files stored in a storage medium for an image file associated with the decoded additional predetermined information; and
computer-executable instructions for printing the image of the image data in the searched image file under the print conditions set in accordance with the decoded print setting information.
